(19) United States
(12) Patent Application Publication
(10) Pub. No.: US 2008/0005281 A1
(43) Pub. Date: Jan. 3, 2008

(54) Error capture and reporting in a distributed computing environment

(75) Inventors: Walter C. Hsueh, San Mateo, CA (US); Scott M. Isaacs, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/478,036

(22) Filed: Jun. 29, 2006

(51) Int. Cl. G06F 15/16

(52) U.S. Cl. 709/219

(57) ABSTRACT

Errors are captured, packaged, and reported in a client application and sent to a server computer for logging and diagnosis in a distributed computing environment. Client applications may package pertinent information about the client system configuration, the state of the client application at the time of the error, and other useful information, and send the packaged information to a server computer so that developers may identify and diagnose problems and monitor an application's performance. One example includes error capturing and reporting of various scripts that are operable within a client browser application.

### BACKGROUND

Many computing applications are using a distributed computing environment, where a portion of an application operates on a server, and another portion operates on a client computer. One example of such an environment is a web browsing environment where some of the executable code is run on the client's browser.

Errors that occur on the server side can generally be detected and diagnosed because the administrators or program developers are usually able to monitor the performance of the servers directly. When an error occurs, especially on the client side, it can be difficult to diagnose the problem because the administrators do not have direct control over the client computers. This problem is exacerbated when an application is used with several different web browsers, different operating systems, and a myriad of different computer configurations across the world.

Error reporting and diagnosis is a key component of the initial debugging process but also in monitoring and improving processes after a software application or component has been released into general use. Thus, any improvements in the error capturing and reporting capabilities in the difficult distributed computing environment will be most welcome.

### SUMMARY

Errors are captured, packaged, and reported in a client application and sent to a server computer for logging and diagnosis in a distributed computing environment. Client applications may package pertinent information about the client system configuration, the state of the client application at the time of the error, and other useful information, and send the packaged information to a server computer so that developers may identify and diagnose problems and monitor an application's performance. One example includes error capturing and reporting of various scripts that are operable within a client browser application.

### BRIEF DESCRIPTION OF THE DRAWINGS

In the drawings,

FIG. 1 is a pictorial illustration of an embodiment showing a system for error capture and reporting.

FIG. 2 is a timeline illustration of an embodiment showing a method for error capture and reporting.

FIG. 3 is a flowchart illustration of an embodiment showing a method for error capture and reporting.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

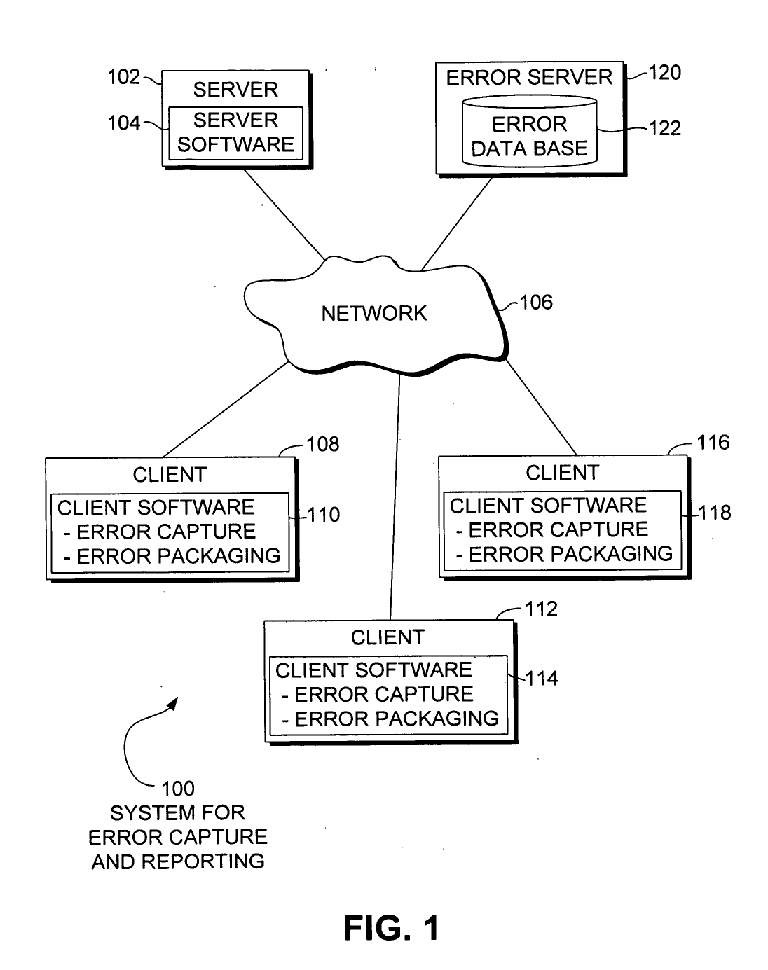

FIG. 1 is a diagram of an embodiment 100 showing a system for error capturing and reporting. A server 102 is running server software 104 in a distributed computing environment. The server 102 communicates through the network 106 to various clients 108, 112, and 116. Client 108 is running client software 110 that is capable of error capture and reporting. Similarly, client 112 is running client software 114 and client 116 is running client software 118. When any of the client software 110, 114, or 118 encounters an error, the client software may capture the error, and report the error along with any pertinent information to the error server 120, which may store the error information in an error database 122.

The embodiment 100 is an example of using client software in a distributed computing environment to capture and report errors. One example of such a distributed computing environment is web based applications that use various scripting languages to perform some functions on a user's web browser. When an error occurs, especially one that occurs on the client side, the error is captured and reported. Such data is very valuable for debugging applications, as well as monitoring performance of such applications over time.

The term ‘software’ is synonymous with ‘executable code’. Such code may come in the form of executable binary programs, interpreted scripts, firmware, or any instruction by which a processor, programmable state machine, or other device may perform a task. Throughout this patent application, any such term such as ‘software’, ‘code’, ‘instructions’, or other similar terms shall be synonymous with ‘executable code’.

The client software 110 may be capable of basic error capture and reporting. Such an embodiment may include detecting that an error has occurred and reporting the type of error. More sophisticated embodiments may be able to locate a line number or other identifier within the application where the error occurred, collect relevant data relating to the operation of the application, collect data regarding the system on which the client is operating, create an error reporting package, encrypt the package, and transmit the package to the error server 120.

The level and complexity of the error capture and reporting capabilities may vary widely, based on the type of application, the tools used to develop the application, and the hardware on which the application runs.

Many different applications can operate in a distributed computing environment. Many such applications use a client-server approach, where a central server 102 operates in conjunction with many clients 108, 112, and 116. The various clients may be disparate devices with different types of processors, running different operating systems, and may have widely varying architectures. One example is a web browser operating on several different clients, wherein each browser runs client software 110 in the form of a script within the browser. The script, operating within the browser, may be complex enough to detect that an error has occurred, collect data about the error, and transmit the data to an error server 120.

In another embodiment, a distributed computing environment may include small applications, extensions, add-on programs, or other application subsystems that are distributed through a server 102 and may operate in conjunction with the server software 104. The add-on programs or extensions may be operable within a host application. In some embodiments, the program code that performs the error capture and reporting may be present within the add-on program or may be present within the host application. The performance of such add-in programs or extensions may be monitored and through the errors caught and reported in the error database 122.

The host program may be a basic application in which various tools, extensions, application programming interfaces (API), or other interfaces may enable a computer operable routine to interact with the host program. The host program may be part of a distributed computing environment whereas the add-on programs, extensions, or other programmable code may operate on the client device.

The server 102 may be any device able to communicate on the network 106 and adapted to operating in a distributed computing environment. In some embodiments, a majority of the computational processing for an application may be performed on the server 102, while in other embodiments, most of the processing may be performed on the various clients. The server 102 may distribute the client software 110 in addition to performing a portion of the processing for a particular application.

The server 102 may be a single device, such as a server computer or other network enabled device, or may be a collection of devices that operate as a server, such as a cluster of servers. Some embodiments may include load balancing devices, high performance clusters, redundant systems for high availability, or other technologies useful in the management and operation of server-type devices.

The error server 120 may be the same physical and/or logical device as the server 102. In some cases, the error server 120 may be a specialized error reporting, logging, and record keeping service that is used across multiple computing applications and computing platforms. Some embodiments may use two or more error servers, where one may be used by application developers for debugging and another used for performance monitoring, for example.

The database 122 may be used to generate reports and other output that may be useful in many circumstances. Error reports may be generated using any parameter within the database. For example, error reports that include the manufacturer of the client device may be used to compare different device manufacturers in various applications. In another example, various error reports may highlight software manufacturers with very good track records or very poor track records for bugs in their code. Because there are no limits to the type and quantity of data that can be captured and reported, so also are the reports and outputs of the database 122 unlimited.

The client devices 108, 112, and 116 may be any type of device capable of operating in a distributed computing environment. A classical example may be personal computers, but the devices 108, 112, and 116 may include cellular telephones, personal digital assistants, various internet appliances, or other devices. In some cases, the client devices may be end user devices, but in other cases the client devices may be other hardware, such as network routers, switches, or other non-end user devices.

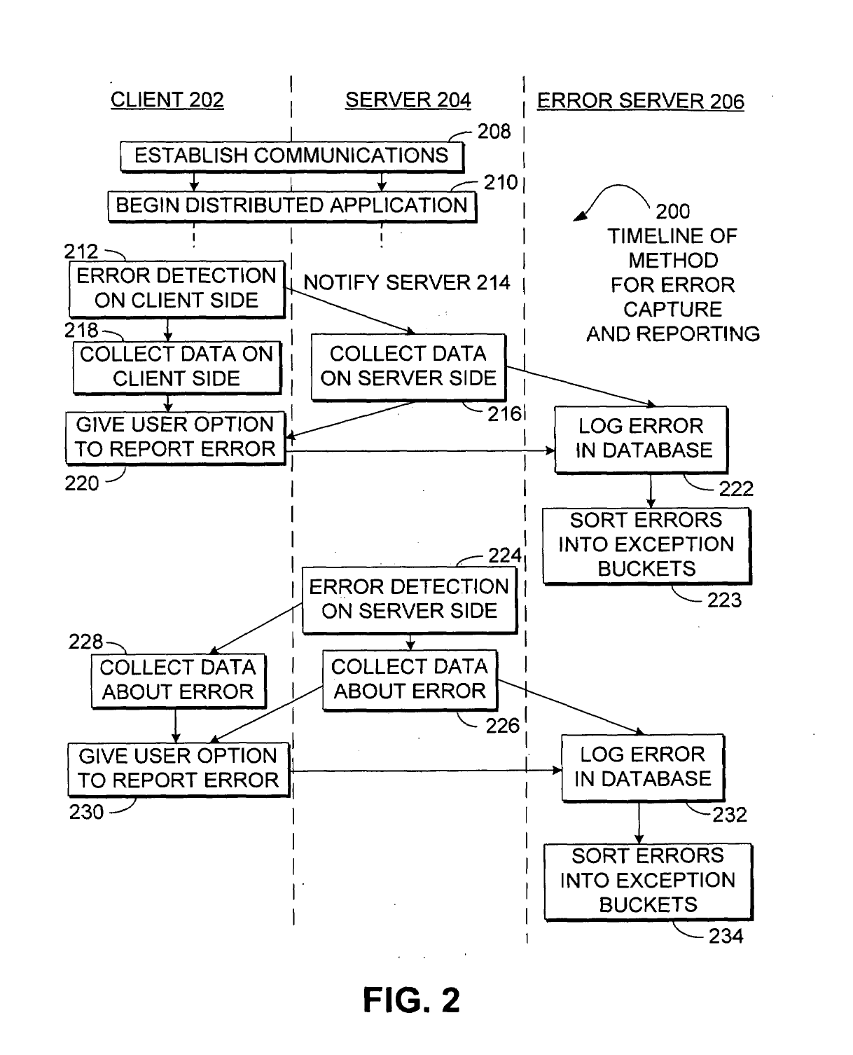

FIG. 2 is a timeline diagram of an embodiment 200 showing a method for error capturing and reporting. The activities performed by the client 202, server 204, and error server 206 are shown in the respective columns. In block 208, communications are established between client 202 and server 204, and in block 210, the distributed application is begun between the two devices.

In block 212, an error is detected on the client 202. The server 204 may be notified 214 and, in block 216, data pertaining to the error may be collected on the server. The client 202 may collect data pertaining to the error in block 218. The user may be given an option to report the data in block 220, whereupon the error will be logged on the error server 206 in block 222. The errors may be sorted into exception buckets in block 223. In some cases, the data collected in block 216 may be logged in block 222 regardless if the user authorizes the logging in block 220, while in other cases, the data may be transmitted to the error server 206 only after the user authorization in block 220.

In block 224, an error is detected on the server 204 and data pertaining to the error is collected from the server 204 in block 226. Data pertaining to the error is collected from the client 202 in block 228. The user may be given an option to report the data in block 230, after which the error may be logged to the error server 206 in block 232 and the errors sorted into exception buckets in block 234.

Embodiment 200 illustrates two different scenarios: one where an error is detected on the client side, and another where an error is detected on the server side. In both cases, data are collected pertaining to the error on the client side and reported to the error server 206. Data collected on the client side are often very difficult to obtain for the application developer, as these data may disappear when error recovery is attempted. Further, the client devices may be much more diverse than those devices used during application development, and getting error feedback from a very wide spectrum of clients may be very useful for developing robust application code. Data collected from the server side may be equally useful and even more so when paired with corresponding data from the client side.

Embodiment 200 is useful for client executable code that is operating within a browser environment, such as a world wide web browser. In many cases, the client executable code operates within a browser environment and in conjunction with server executable code to provide a computer application. Such an architecture may be used for a limitless array of applications, including email clients, applications that interface with databases or file systems over the network, or any other application where a client-server architecture is useful.

In an example of an email client, the client may interface with a server and the client may perform various functions for reading, creating, displaying, and organizing email. Such a client may enable drag and drop organization, one click operations such as identifying junk mail, automating replies, various editing functions, etc. Such an example may use considerable amount of executable code running within a web browser and is an example of a feature-rich application that can be easily portable and widely distributed.

When an error occurs, be it detected by the client or server, the circumstances surrounding the error may be useful in diagnosing the cause of the error. Even though the error was detected on the server, the cause may have been software or hardware configurations on the client, and vise versa. By collecting all the pertinent data, a better diagnosis can potentially be achieved.

A client may include error detection and capture capabilities. An error may occur at any point during the execution. In some cases, the client executable code may include specific sections of code where data or other conditions are compared to detect an error. In other cases, an error may occur unexpectedly. In the first case, the error capture routine may designate one or more variable values and create a detailed message that defines the error condition.

When an error occurs unexpectedly, the data collection routine exemplified in block 218 may include a dump of as much information as could possibly be helpful in diagnosing the cause of the error. Such information may include a Javascript stacktrace, back traced argument list, or similar dump of variables and states from the client code. The exact nature of the stacktrace or similar dump may depend on the programming environment, runtime capabilities, and browser features available. In some embodiments, all available information and data may be collected. In other embodiments, an application developer may select certain data to be collected for specific errors so that unnecessary data do not need to be subsequently processed.

When data are collected about the error, a user may be given the option to send an error report to the error server 206. This is to give the user control over whether data about their system are reported to a third party. In some cases, the data collected on the server side may be stored without the user's input. In such a case, the server may log errors directly without notifying the user or asking for the user's input. When data are collected from the server 204 and transmitted to the client 202, such as from block 226 to block 230, some or all of the data may be encrypted.

The data pertaining to an error may be collected by both the client 202 and the server 204. After collection, the data may be further packaged by the client 202 and then stored in the error server 206. Some embodiments may perform some additional processing of the data during the packaging step, such as performing some preliminary analysis, encrypting the package, or other steps. Preliminary analysis by the client 202 may include determining the severity of the error and selecting an appropriate error recovery mechanism to perform before or after the error is reported and logged.

In many embodiments, the collected data may be sorted into ‘exception buckets’ after collection. The exception buckets may be a method by which the data may be sorted and classified for reliability and performance tracking over an extended period of time. Examples of exception buckets may include the client computer operating system platform, browser major and minor version, web server version, messages provided by the browser or other run-time software on the client or server, and line numbers where an error occurred.

Some embodiments may give a user an option to send the entire set of error data in blocks 220 and 230. The entire set of data may include either or both the client or server data, depending on the situation. Other embodiments may send a minimum set of data without the user input, but send a complete set of data with the user input. Still other embodiments may report the entire set of data without any user input. The rules relating to user input may be determined by the type of application. For example, if the application were operated within a company where both the server 204 and clients 202 were on a private, company-owned network, the administrator may require complete error recording without offering the user an opportunity to decline. In another example, if the application were operated on the internet with any client device worldwide, certain privacy laws, end user license agreements, or other requirements may prohibit sending information about a user's client device without the user's permission.

The error server 206 may be a server that is controlled and operated by an application developer and used for debugging the application code. In other uses, the error server 206 may be a third party designated to collect and report performance of various applications across different developers. Such a use may be a government regulatory agency, consumer reporting agency, non-profit monitoring group, or other such institution. Another use may include an error server 206 maintained by the providers of an application development software tools or underlying application. A tool provider or other third party may provide error reporting services for free or for a fee.

Some embodiments may include encrypting the data prior to transmission. Encryption may be desired especially when server errors are captured, as the collected data or stacktrace may include detailed information about the server operation. In some cases, the client executable code may be distributed in a fashion whereby a user can view or decompile the code and thus understand the inner workings of the code. In embodiments where the server code is not distributed or otherwise available, encryption of the data may be useful to protect the proprietary nature of the inner workings of the server executable code.

Encryption may also be used in cases where information about the user or the user's system is transmitted over the open Internet. In some embodiments, a user may be given the option to share pertinent data that would be helpful in debugging an application and such data may include some identifying information about the user. Such information may be encrypted prior to transmission. In other embodiments, all user-specific data, including data that could be potentially used to identify a user, may be omitted from any data collection. Each application may have different policies concerning data collection from the client system, and such policies may vary in different situations.

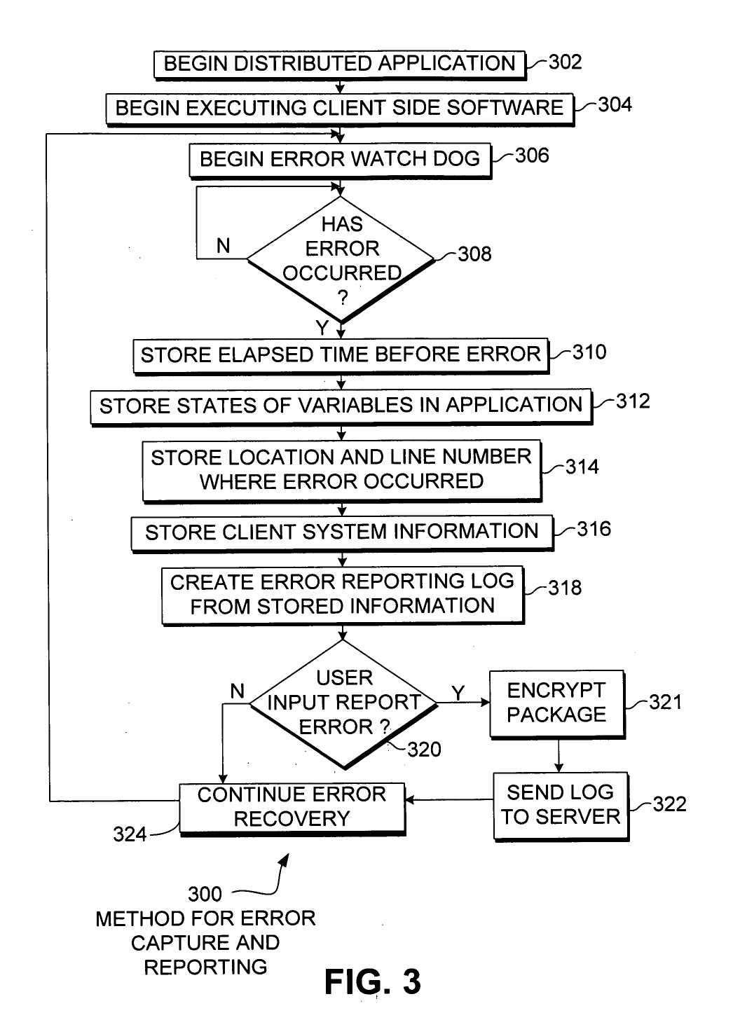

FIG. 3 is a flowchart representation of an embodiment 300 showing a method for error capture and reporting. A client/server application is begun in block 302, and the client side software is begun in block 304. As part of the client side software, an error watchdog routine or thread is started in block 306. The watchdog routine monitors for an error condition in block 308. If no error exists in block 308, the routine loops back on itself in block 308. When an error occurs in block 308, the elapsed time before the error occurred is stored in block 310. In block 312, the states of some or all of the variables used by the client/server application are stored, as is the location within the executable code and line number where the error occurred in block 314. Client system information is stored in block 316. An error reporting log is stored in block 318. The user is prompted in block 320. If the user responds affirmatively in block 320, the error log may be encrypted in block 312 and sent to a server in block 322. Error recovery is continued in block 324. If the user responds in the negative in block 320, the error log is not sent to the server, but error recover continues in block 324.

Embodiment 300 is one method by which errors may be captured and reported. Different embodiments may use different technologies and different methods to accomplish error capturing and reporting. In the present embodiment, a watchdog routine is created to continually scan for errors or problems. When an error occurs, the watchdog routine may capture several different types of data before any further error recovery is attempted. In this manner, the states of variables or other data are not disturbed or reset when error recovery has started.

The use of a watchdog routine is one method by which an error capture and reporting system may be started. Other embodiments may use different techniques for identifying an error and starting the data storage process. Such embodiments may reflect the development tools or languages used by an application developer, the hardware or underlying software operating on the hardware, or other situations. Any mechanism may be used to detect and capture an error.

The data captured because of the error may vary from application to application. For certain types of errors, some information may be more useful than others. Further, some data collection systems may use a standardized error reporting system that collects certain data regardless if the data are pertinent to the precise error. In other embodiments, an application developer may specify which data are to be collected for a specific error.

In block 310, the elapsed time for the error to occur is stored. The elapsed time may be from a specific point in the application, such as the time from the start of the application, from the last user interaction, from the last communication with the server, or from some other known point in the application execution. In some embodiments, the actual time be determined from a real-time system clock or other real-time source. Each embodiment may use a different measure for the elapsed time, depending on the type of application and the use of the data afterwards.

Variable states are stored in block 312. In many cases, the states of certain variables may be important tools for a developer to debug an error. All of the variables, or a selected subset of variables, may be captured for a specific error.

When feasible, the line number or other location information regarding the error may be captured in block 314. This data may be also be helpful in debugging an error.

Client system information in block 316 may include any pertinent information regarding the client system. This may include information such as the processor, available memory, operating system. Additionally, the information may include other applications that are operating simultaneously on the system, identifying information about the user, user data used within the application, and other information that may or may not be personal or private in nature. In some embodiments, such information may be encrypted when transmitted and may be subject to legal agreements or laws regarding personal privacy.

When the error log is sent to the server in block 322, the error log may be encrypted. The encryption may be in part to protect any personal information about the user, but may also be in part to protect the technology, programming practices, or other trade secrets embedded in the application code.

The error recovery in block 324 may include any routine by which the application may continue. This may include restarting the application, wiping out or resetting variables, restarting or redirecting the executing routine, or any other error recovery technique. In some cases, the error recovery technique may include changing variables, pointers, counters, or other indicia that was captured in the blocks 310 through 316. Thus, the error capture routines of blocks 310 through 316 may be performed before the error recovery routine in block 324 so that pertinent and useful data for debugging may be captured.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A client in a distributed computing environment comprising:
a connection to an application server computer;
wherein said client is adapted to operate in conjunction with a server executable code as part of a computer application; and
wherein said client executable code is adapted to detect than an error has occurred, gather information pertaining to said error, transmit said information to an error capture computer, and sort said information into exception buckets.

2. The client of claim 1 wherein said client executable code is executed in a world wide web browser.

3. The client of claim 1 wherein said error capture computer is said application server computer.

4. The client of claim 1 wherein said information comprises at least one of a group composed of:
line number of said client executable code where said error occurred;
the state of at least one variable;
elapsed time between a known point and said error; and
computing system identifiers for said client computer.

5. The client of claim 1 wherein said error having occurred in either said client executable code or said server executable code.

6. The client of claim 1 wherein said client executable code is further adapted to give a user an option to send said information.

7. The client of claim 1 wherein said exception buckets comprise at least one of a group composed of:
operating system platform;
world wide web browser major version number;
world wide web browser minor version number;
web server version;
exception message generated by said client executable code; and
line number of said error.

8. The client of claim 1 wherein said information comprises a stacktrace.

9. The client of claim 1 wherein said client is at least a portion of an email interface.

10. A method comprising:
connecting a client computer to a server computer, said server computer operating server executable code;
downloading client executable code to said client computer;
running said client executable code on said client computer;
while using said client computer, detecting that an error has occurred, gathering information pertaining to said error, transmitting said information to an error capture computer, and sorting said information into exception buckets.

11. The method of claim 10 wherein said client executable code is executed in a browser.

12. The method of claim 11 wherein said browser is a world wide web browser.

13. The method of claim 10 wherein said error capture computer is said server computer.

14. The method of claim 10 wherein said information comprises at least one of a group composed of:
line number of said client executable code where said error occurred;
the state of at least one variable;
elapsed time between a known point and said error;
and computing system identifiers for said client computer.

15. The method of claim 10 wherein said error having occurred in said client executable code.

16. The method of claim 10 wherein said error having occurred in said server executable code.

17. The method of claim 10 further comprising giving a user an option to send said information.

18. The method of claim 10 wherein said exception buckets comprise at least one of a group composed of:
operating system platform;
world wide web browser major version number;
world wide web browser minor version number;
web server version;
exception message generated by said client executable code; and
line number of said error.

19. A client in a distributed computing environment comprising:
a connection to an application server computer;
wherein said client executable code is adapted to:
operate in conjunction with a server executable code to implement an application;
detect than an error has occurred, gather information pertaining to said error, encrypt at least a portion of said information, and transmit said information to an error capture computer, said error having occurred in either said client executable code or said server executable code;
said client executable code being adapted to by executed within a world wide web browser;
wherein said information comprises at least one of a group composed of:
line number of said client executable code where said error occurred;
the state of at least one variable;
elapsed time between a known point and said error; and
computing system identifiers for said client computer.

20. The client of claim 19 wherein said client executable code is further adapted to give a user an option to send said information.
